(19) United States
(12) Patent Application Publication
(10) Pub. No.: US 2026/0154943 A1
(43) Pub. Date: Jun. 4, 2026

(54) MULTI-OBJECT CLUSTER DETECTION VIA UNIFIED COMPUTER VISION MODEL

(71) Applicant: Walmart Apollo, LLC, Bentonville, AR (US)

(72) Inventors: Zhaoliang Duan, Frisco, TX (US); Lingfeng Zhang, Flower Mound, TX (US); Avinash Madhusudanrao Jade, Bangalore (IN); Ishan Arora, Bengaluru (IN); Mingquan Yuan, Flower Mound, TX (US); Eric W. Rader, Plano, TX (US); Ashlin Ghosh, Ernakulam (IN); Abhinav Pachauri, Bangalore (IN); Han Zhang, Allen, TX (US); Raghava Balusu, Achanta (IN)

(21) Appl. No.: 18/964,204

(22) Filed: Nov. 29, 2024

(51) Int. Cl. G06V 10/762; G06V 20/50; G06V 20/70

(52) U.S. Cl. CPC G06V 10/762; G06V 20/50; G06V 20/70

(57) ABSTRACT

Examples provide a multi-object cluster detection model for identifying instances of items arranged in clusters of objects of interest using input images of a selected area generated by an image capture device. A cluster detection manager identifies instances of each different cluster of items within the image based on size, shape, and color of the objects as well as the proximity of the items to one another.

Labeled image data is generated using the image. The labeled image data includes cluster indicators identifying unique clusters in the image. The labeled image data is used to determine the number of different clusters in a location. The system generates an alert if the detected number of clusters differs from an expected number of clusters for the given location. The system utilizes cluster detections to update item data, identify out-of-stock items, identify incorrectly placed items, validate automated item-to-location mapping, and verify item identifications.

### BACKGROUND

Computer vision (CV) object recognition can be used to analyze images of products and other objects within a store, warehouse, distribution center or other retail facility to automatically identify products, signs, location tags, shelving, and other objects using input images of the objects. However, an object detection model is generally only able to detect a single type of object. A different object detection model is required to detect each different type of object of interest. In order to detect and recognize two different types of objects, such as pallets and signage, two different object detection models are trained and maintained. Likewise, detecting three different types of objects of interest entails training and maintaining three individual object detection models. As the number of types of objects of interest increases, the number of individual models required to accurately identify those objects using image data also increases, hindering scalability. This is also inefficient, impractical, and potentially cost-prohibitive.

### SUMMARY

Some embodiments provide a system and method for multi-object cluster detection with improved accuracy. An image of an item storage structure at a location within a retail facility. The item storage structure stores one or more items.

The image is captured by an image capture device. The image is analyzed using a multi-object cluster detection model. The model detects unique clusters of items of interest. The system generates a labeled image including a plurality of indicators.

Each indicator is associated with a cluster of items detected within the image. The number of unique clusters at the location of the item storage structure is identified using the labeled image.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for cluster detection via a unified computer vision (CV) model.

FIG. 2 is an exemplary block diagram illustrating a retail facility having a plurality of clusters associated with at least a portion of an item storage structure.

FIG. 3 is an exemplary block diagram illustrating a cluster detection manager for detecting clusters of items of interest using a unified CV model.

FIG. 4 is an exemplary block diagram illustrating labeled image data.

FIG. 5 is an exemplary block diagram illustrating labeled image data including a plurality of indicators associated with a plurality of clusters of items on an item storage structure.

FIG. 6 is an exemplary flow chart illustrating operation of the computing device to detect clusters of items in an image of an item storage structure.

FIG. 7 is an exemplary flow chart illustrating operation of the computing device to generate labeled image data including cluster indicators.

FIG. 8 is an exemplary flow chart illustrating operation of the computing device to identify incorrectly placed items and out-of-stock items using labeled image data.

FIG. 9 is an exemplary flow chart illustrating operation of the computing device to map clusters of items to locations within a retail facility.

FIG. 10 is an exemplary flow chart illustrating operation of the computing device to validate inventory data using cluster detection results.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

It is frequently desirable to automatically detect clusters or groups of items of interest within digital images of an area, such as, but not limited to, a sales floor, a reserve area, item display, storage area, and/or other area in a store, warehouse, or distribution center. Computer vision (CV) can be used to detect an item of interest from input images. However, a different model is typically required for each different type of item of interest. For example, a model trained to detect and recognize pallets would typically be unable to also recognize item storage structures, shopping carts, display case doors, etc. Other models are trained to recognize these other types of objects. Thus, to detect two different types of items, such as a stack of bottles and a stack of boxes on a shelf in a given image would require two or more different object detection models separately trained to detect the shelf, and one or more other models trained to detect the bottles and the boxes. This is inefficient, cumbersome and resource intensive. Moreover, detecting pallets, pallet tags, pallet bins, clusters of items, display case doors, item storage structure members, void spaces, and other objects of interest in images using CV is frequently inaccurate and unreliable. This results in issues associated with accurately and efficiently identifying objects within a retail facility.

Moreover, to identify item outs on shelves and/or update inventory a user is generally required to make a visual inspection of product shelving and other display cases in a store or other retail space, such as a retail facility, warehouse, or distribution center (DC). This manual process is time consuming and inefficient.

Some systems can identify clusters of items on shelves using image data. However, accurate identification of each item may be difficult or impossible. Incorrect identifications may be assigned to the items and/or clusters of items. Moreover, these systems require multiple trained ML models to detect each different type of item rendering these systems inefficient, error prone, and unscalable.

Referring to the figures, examples of the disclosure enable a multi-object cluster detection model. In some embodiments, the multi-object cluster detection model is used to identify a plurality of clusters of different types of objects of interest based on attributes of the different types of objects, such as, but not limited to, color, size, and/or shape of each different type of object. The multi-object cluster detection model is further enabled to determine the number of different types of objects (number of unique object clusters) as well as the number of items in each cluster of different object types within one or more images of a selected area, such as display cases, shelving, etc. An object can include any type of object, such as an item (product), case of items, pallet of items, etc. An item can include a single item as well as packaging including two or more instances of one or more items, such as a party pack of chips or a case of drink bottles.

An object type is a classification or category in which a type of object fits, such as a case of soft drinks, a box of crackers, a bag of chips, a bottle of soap, etc. The plurality of objects of interest includes two or more different objects associated with two or more different object types. A cluster is a grouping of two or more instances of an item of the same object type. This enables utilization of a single trained multi-object cluster detection model to detect and recognize multiple different types of objects in multiple clusters within a given location captured in one or more images of the location. In this manner, the system trains and stores a single model in memory for multi-object cluster recognition of groups of different types of objects instead of training and storing two or more models in memory for reduced system memory and processor resource usage.

Some embodiments of the disclosure enable a trained deep learning convolutional neural network (CNN) model to analyze a plurality of images of a location, such as an item storage area, to detect clusters of different types of items and/or the number of different types of items in an area more accurately for use in inventory, locating items within the store, updating planograms, restocking shelves, identifying incorrectly placed (misplaced) items, etc. The system reduces user time which would otherwise be spent manually searching for items in a retail facility, manually updating inventory, storing detected item cluster locations and identified number of clusters in a database, manually checking shelving for item outs, and/or reduces errors in identifying the location of items within a retail facility enabling more accurate and efficient location of objects of interest as well as more accurate inventory information.

Other embodiments provide a cluster detection manager that generates a labeled image of a selected area by adding an overlay including labels and/or color-coded indicators to a selected image. Each type of indicator is associated with a different cluster of objects. Each cluster includes instances of a different type of object. Thus, an image overlay having two or more different types of indicators associated with two or more different recognized clusters of objects of interest is provided. This image enables multi-object cluster recognition by a single object recognition model with improved accuracy and reduced system resource usage. The recognized clusters are mapped to the recognized location of the objects for improved accuracy identifying current item counts on a sales floor, locating item outs, and/or updating inventory within a retail space quickly and efficiently with reduced system resource usage.

In other embodiments, the recognized and labeled clusters of objects of interest in a labeled image are presented to a user via a user interface (UI). The labeled image provides labeled clusters of objects of interest linked to a recognized location. This enables faster and more accurate identification and location of different types of objects of interest which increases user interaction performance and improves user efficiency via the UI.

Aspects of the disclosure further enable multi-object cluster detection for inventory update, restocking and identifying misplaced items on a sales floor using a combined object detection model. The computing device operates in an unconventional manner by accurately detecting different types of objects in multiple clusters within a field of view (FOV) of a color image generated by an image capture device using a single multi-object cluster detection model. In this manner, the computing device is used in an unconventional way, and allows improved accuracy and efficiency in detecting multiple instances of different types of objects by a single, unified cluster detection model which conserves memory and reduces processor load while further reducing item-to-location mapping errors, thereby improving functioning of the underlying computing device.

The system, in other embodiments, is predicting the number of unique clusters of items in each location. The system calculates a confidence score and/or a ranking for each detected cluster of items. The confidence score and/or ranking indicates how likely it is that an identified cluster of items is a unique item cluster. A unique item cluster is a cluster having one or more items of a different type than any other cluster. For example, a bottle of organic apple juice is a different type of item than a bottle of apple juice of the same brand that is not organic. Thus, a cluster having the organic apple juice is a unique cluster and the cluster having the regular bottle of apple juice is a second unique cluster of items. The confidence score is assigned to each detected cluster indicating a degree of confidence that each cluster is a unique cluster representing a unique product on the shelf or other item storage structure. The indicator used to identify each cluster in the labeled image data optionally also includes the confidence score or ranking. This enables faster and more accurate identification of unique items on each shelf with confidence information to inform users regarding the likely accuracy of the cluster predictions. This reduces the error rate and further improves user efficiency via the UI.

In still other embodiments, the system uses the calculated number of clusters to verify item identifications performed by other systems, such as other automated and manual item inventory operations. For example, if inventory data indicates that there are ten unique items or varieties of items assigned to a portion of a shelf, the system can use the detected number of clusters identified at that portion of the shelf to verify that there are indeed ten unique clusters of items representing instances of the ten unique items or varieties of items assigned to the location. This improves user efficiency and reduces errors in the inventory data.

In yet other embodiments, the system verifies accuracy of current inventory of items stocked on a shelf in real-time without identifying each item on the shelf. The cluster detection manager merely identifies the number of unique clusters of items on a shelf or other location without specifically identifying any of the items. In these examples, it is not necessary for the system to know what the item identifier (ID), item name, or any other item information for items detected on the shelf.

Instead, the system simply calculates the number of unique clusters of items. This unique clusters value indicates the number of unique types of items presently on the shelf. If the number of detected clusters equals the number of unique items assigned to be displayed on the shelf in accordance with the item assortment or planogram information, the inventory is correct and can be confirmed or validated. Moreover, the system can determine whether restocking is necessary without identifying the specific item that is out of stock. The system consumes fewer processor and memory resources by identifying the number of clusters instead of identifying individual items on the shelf. In this manner, the system is able to verify inventory and trigger restocking while reducing processor, memory, and network resources consumption.

Other embodiments utilize a single unified computer vision (CV) model to identify clusters of two or more items, item support structure members, void spaces, display case doors, and other objects of interest using a single model rather than multiple CV models. In this manner, the system reduces processor and memory usage which would be consumed by the models. Moreover, the model enables results to be provided in a faster and more efficient manner that reduces user time that would otherwise be required to train and maintain multiple models. This results in improved user efficiency and reduction in system resource usage while providing more accurate inventory updates using the multi-object detections provided by the model.

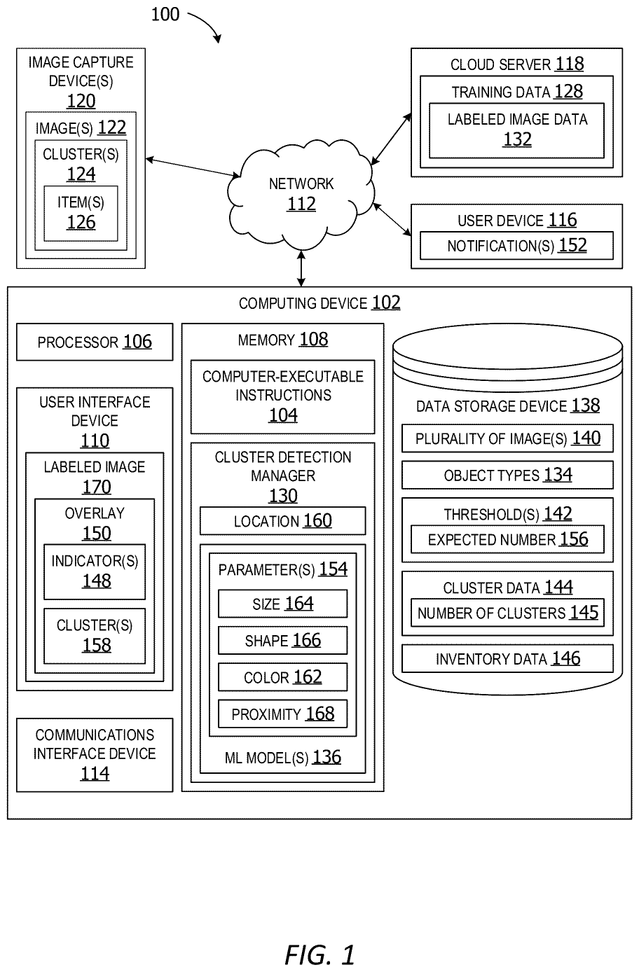

Referring again to FIG. 1, an exemplary block diagram illustrates a system 100 for cluster detection via a unified computer vision (CV) model. In the example of FIG. 1, the computing device 102 represents any device executing computer-executable instructions 104 (e.g., as application programs, operating system functionality, or both) to implement the operations and functionality associated with the computing device 102. The computing device 102, in some embodiments includes a mobile computing device or any other portable device. A mobile computing device includes, for example but without limitation, a mobile telephone, laptop, tablet, computing pad, netbook, gaming device, and/or portable media player. The computing device 102 can also include less-portable devices, such as servers, desktop personal computers, kiosks, or tabletop devices. Additionally, the computing device 102 can represent a group of processing units or other computing devices.

In some embodiments, the computing device 102 has at least one processor 106 and a memory 108. The computing device 102, in other embodiments includes a user interface device 110.

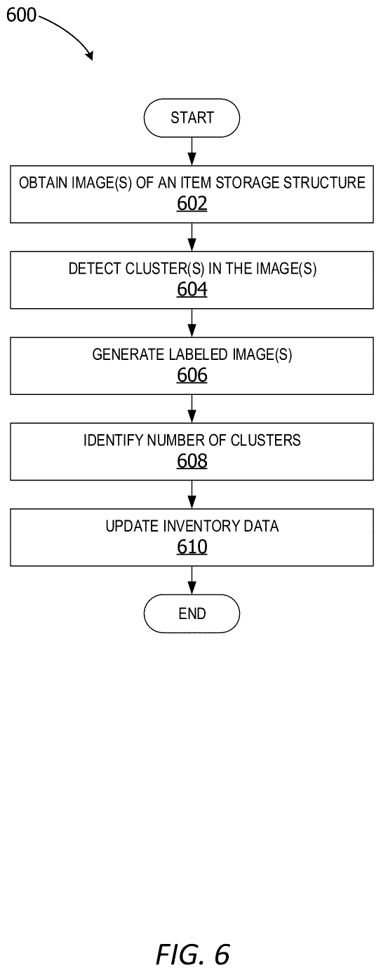

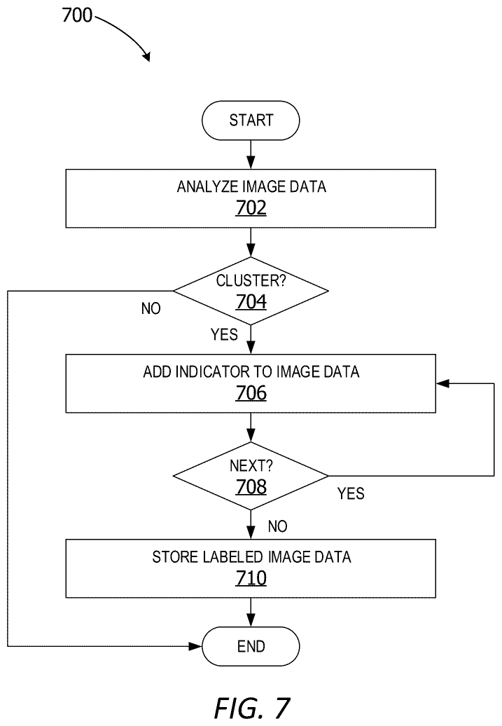

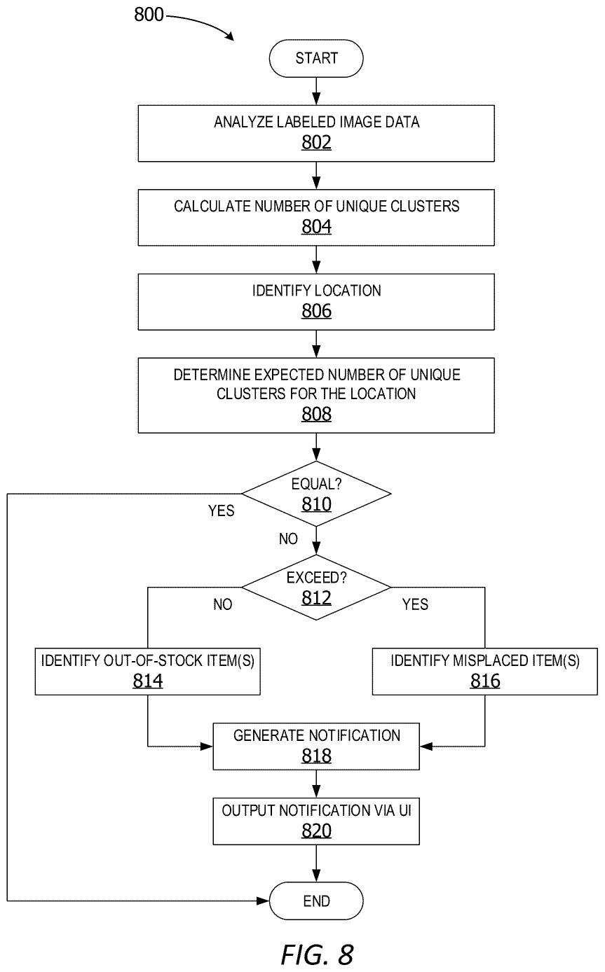

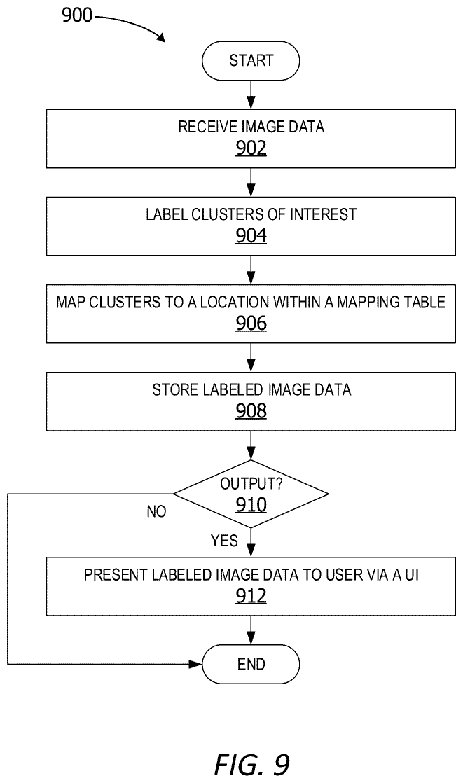

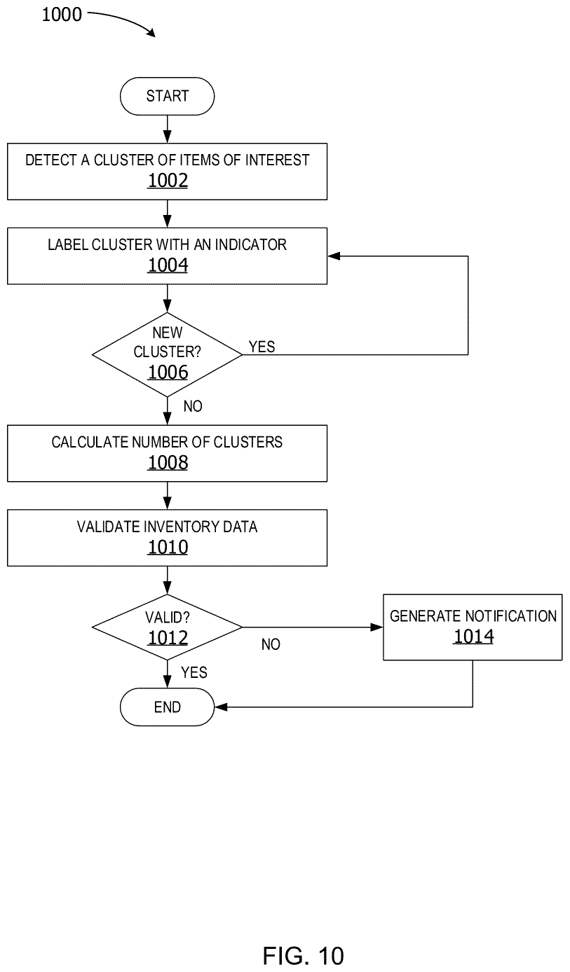

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some embodiments, the processor 106 is programmed to execute instructions such as those illustrated in the figures (e.g., FIG. 6, FIG. 7, FIG. 8, FIG. 9, and FIG. 10).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other embodiments, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other embodiments, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other embodiments, the network 112 is a local or private LAN.

In some embodiments, the system 100 optionally includes a communications interface device 114. The communications interface device 114 includes a network interface card and/or computer-executable instructions (e.g., a driver) for operating the network interface card. Communication between the computing device 102 and other devices, such as but not limited to a user device user device 116, a cloud server 118, and/or one or more image capture device(s) 120, can occur using any protocol or mechanism over any wired or wireless connection. In some embodiments, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory.

The user device 116 can also include a user interface device (not shown).

The cloud server 118 is a logical server providing services to the computing device 102 or other clients, such as, but not limited to, the user device 116. The cloud server 118 is hosted and/or delivered via the network 112. In some non-limiting examples, the cloud server 118 is associated with one or more physical servers in one or more data centers. In other embodiments, the cloud server 118 is associated with a distributed network of servers.

The image capture device(s) 120 includes one or more devices for capturing color image(s) 122 of multiple clusters of objects within an area of interest, such as, but not limited to, an item storage area within a retail environment. The image capture device(s) 120, in this example, includes digital cameras capable of generating still images and/or moving video images of the area of interest. The image(s) 122, in some embodiments, can include black-and-white (gray scale) images. In this example, the image(s) 122 include one or more color images. The image(s) 122 include images of one or more cluster(s) 124 of one or more item(s) 126, such as food items, toys, pet supplies, apparel items, office supplies, books, décor, seasonal items, cleaning supplies, electronics, or any other type of item of interest within the image. An item in the item(s) 126 is any type of object which is provided for sale or lease within the retail facility.

In some examples, the image(s) 122 includes images captured in a series. The image(s) are time stamped to identify a date and time at which each image is generated. In these examples, the system uses multiple images captured within a predetermined time period to identify unique clusters of items on the shelf. In this manner, a cluster which is only partially visible in one image may be completely visible in another image captured within a short period of time after the first image.

An item can include any class and type of item. A class of items is a category or other broader classification for items. An item can fall into one or more of multiple different possible classes of items, such as, but not limited to, a grocery (food) item, tool, item of apparel, cleaning product, pet care item, health care product, decoration, seasonal item, etc. Each class of items can include multiple different object types.

An object type is a more specific classification or category for an item. An item in the apparel class can include any type of clothing, footwear, hat, or other apparel item. For example, apparel includes a coat, baseball cap, socks, pants, t-shirts, etc. Each item has an object type. An object type can be very specific down to different varieties, size options, etc. Object types can fall into different classes. An item of apparel is a different object type than a food item as they are different types of items and different classes of items. Likewise, a hat is a different object type than a jacket even though both the hat and jacket are items of apparel (same class) but still different types of items. A pair of running shoes are a different object type than a pair of sandals. More specifically, shoes of different colors and sizes also fall into different object types. For example, black shoes are a different object type than blue shoes. Spicy chicken nuggets are a different type than regular (non-spicy) chicken nuggets.

In these embodiments, the image(s) 122 do not include images of users or other individuals within the retail facility. Any images having human users or other objects which are not of interest inadvertently included within the images are removed from the image(s) by cropping the images such that only objects of interest remain in the cropped images. Images of users or objects which are not of interest are deleted or otherwise discarded. The cropped images containing only the objects of interest are then analyzed to identify and label the objects of interest within the cropped images, such as, but not limited to, the image(s) 122.

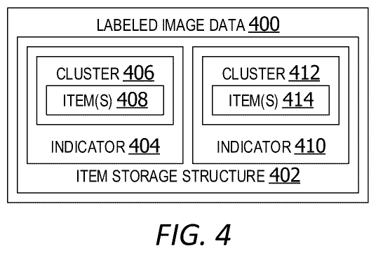

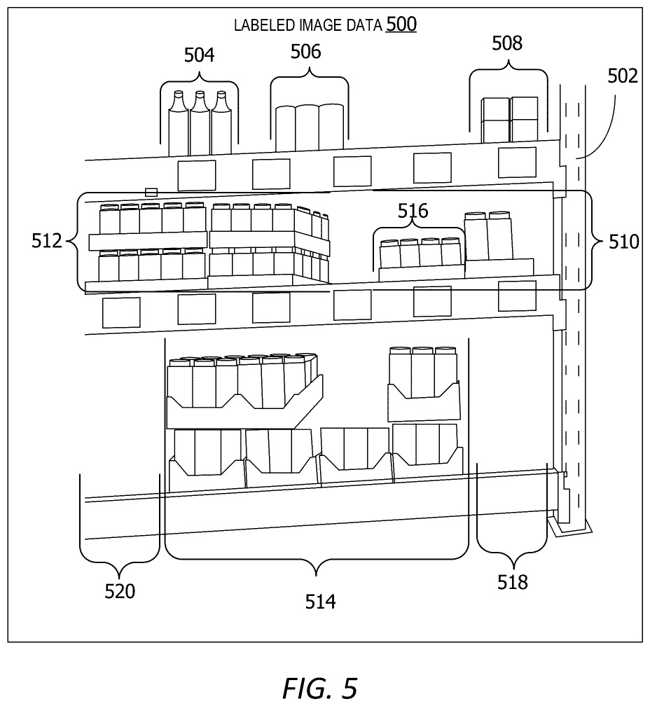

The image capture device(s) 120 optionally include camera(s) mounted on a robotic device, camera(s) incorporated within a user device, hand-held digital camera(s), and/or stationary camera(s) mounted on one or more fixtures within a retail environment, such as a store, distribution center, warehouse, or other facility. In some embodiments, an image capture device is mounted to a robotic device that roams around a retail facility, such as a store, taking pictures of items on item storage structures, such as, but not limited to, items on a shelf, display case, or other structure, as shown in FIG. 4 and FIG. 5 below.

The retail environment can include indoor spaces, outdoor spaces and/or spaces which are partially enclosed and partially unenclosed. The retail environment optionally includes retail stores, warehouses, and/or distribution centers.

The item storage area is an area in which clusters of items are stored or displayed for viewing and/or purchase by users. An item storage area includes, for example but without limitation, shelves, bins, display cases, aisle displays, end cap displays, freezers, refrigerated display cases, or any other area for displaying or storing items associated with a retail facility. The item storage area can include areas inside a physical structure, outside a physical structure, as well as partially enclosed areas, such as a garden center. In some embodiments, the item storage area can also include an area in which pallets and/or individual items are stacked on the floor. The pallets and/or individual items can also be placed on an item storage structure, underneath an item storage structure, and/or adjacent to an item storage structure. An item storage structure can be a single unit, or multiple units attached together via one or more fasteners. A unit includes a bin, display case, shelf unit, compartment, or any other unit associated with an item storage structure. An item storage structure can include multiple different shelves (levels) enabling some items/pallets to be placed at a higher level than other items/pallets. In this example, the pallet storage area is located on a sales floor of the retail facility which is inaccessible to customers. In other embodiments, the pallet storage area is located in a stock room, storage room, or other area which is not on the sales floor.

The cloud server 118 is a logical server providing services to the computing device 102 or other clients, such as user devices. The cloud server 118 is hosted and/or delivered via the network 112. In some non-limiting embodiments, the cloud server 118 is associated with one or more physical servers in one or more data centers. In other embodiments, the cloud server 118 is associated with a distributed network of servers.

In this example, the cloud server 118 includes a cloud storage for storing data, such as, but not limited to, training data 128. The training data 128 is customized training data including labeled image data 132. The training data 128 includes color images of objects of interest associated with different object types 134 items in multiple different object types and/or classes. The images include color images used to distinguish different types of objects based on color 162, size 164, and shape 166 of the items in the image(s) 122.

In some embodiments, the cluster detection manager 130 includes one or more machine learning (ML) model(s) 136. The ML model(s) 136 include a CV multi-object cluster detection model which is trained to detect unique different types of items and/or different clusters of items. The ML model(s) 136 label the detected clusters based on the object types and/or the object classes for the object type associated with each detected item or cluster of items within one or more of the images.

Different types of items are associated with different object classes. The different types of items include, for example, but without limitation, clusters of items, item storage structures, display case doors, pallets, pallet tag objects, pallet wooden base objects, items in an item storage area, item tags (price tags and item identification tags), location tags, pallet steel vertical bar objects, pallet steel horizontal bar objects, void (empty) spaces, and/or pallet partial-empty spaces. The item storage structure can include a shelving unit, a display case, a peg board, a display bin, or any other type of structure. The display case can include a refrigerated display case, a freezer display case, etc. A display case door includes a freezer display door, a refrigerated display case door, or any other type of display case door.

In some embodiments, the different classes of objects include an item cluster class, pallet-related object class, location-related object class, and/or space-related object class. Pallets, pallet wooden bases and pallet tags are included in the pallet-related object class. Steel horizontal bars and steel vertical bars are in the location-related object class. The void (empty) spaces and partial-empty spaces are objects in the available space-related class. Items in the item cluster class includes any group of one or more items, such as a stack of canned goods, a row of milk jugs, a group of jars, cases of soft drinks, or any other group containing multiple instances of an item.

The system 100 can optionally include a data storage device 138 for storing data, such as, but not limited to the plurality of image(s) 140 obtained from the one or more image capture device(s) 120, the plurality of object types 134, one or more threshold(s) 142, cluster data 144, and/or inventory data 146. The data storage device 138 in other embodiments can store other data, such as cluster indicator(s) 148, labeled image data 132, notification(s) 152, parameter(s) 154, location data, and/or any other type of data associated with cluster detection. The system optionally assigns a cluster ID to each unique cluster detected in one or more images.

The threshold(s) 142 include one or more threshold or threshold ranges used to determine whether a correct number of items and/or clusters of items are detected on a shelf or other item storage structure. In some embodiments, the threshold(s) 142 include an expected number 156 of cluster(s) 158 of items are detected in a given location 160.

The cluster data 144 is data associated with a detected cluster of items, such as, but not limited to, a number of clusters 145 detected in the image, location 160 of the cluster, type of the items in the cluster, size of the items in the cluster, proximity 168 of each item to one or more other items and/or proximity 168 to a portion or member of an item storage structure, etc. Proximity refers to the distance between one item and another item or object.

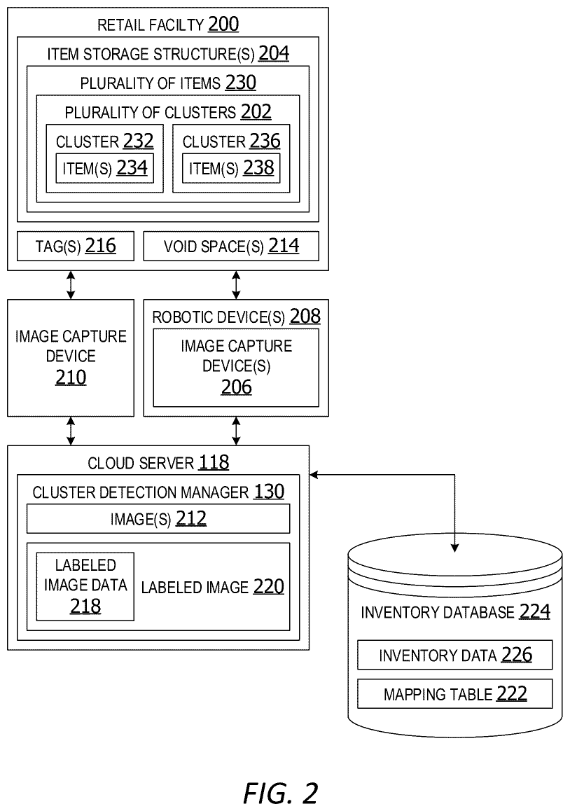

Inventory data 146 is data associated with an inventory of a retail facility, such as, but not limited to, the retail facility 200 shown in FIG. 2 below. The inventory data 146 includes item data, an expected number of clusters in a location, item identifier (ID), location identifier (ID) for an item, item assortment data, planogram data, or any other inventory related data.

The indicator(s) 148 includes one or more different indicators used to identify or otherwise label one or more unique clusters of one or more items in an image. The indicator(s) 148 can optionally include color-coded indicators. A color-coded indicator is an indicator having a distinctive color associated with a given object type or object class. For example, the indicator for a cluster of items can include a red bounding box or red tag while the indicator for a different cluster of items is a blue bounding box and/or a blue tag. In this embodiment, each different cluster of items is identified in an image overlay 150.

The image overlay 150 is an overlay having a plurality of indicators 148 identifying each instance of a cluster of interest in the image. The indicators 148 optionally include a color-coded bounding box and/or a label/tag having text identifying the object type of each cluster of interest detected in the image(s) 122.

The data storage device 138 can include one or more different types of data storage devices, such as, for example, one or more rotating disks drives, one or more solid state drives (SSDs), and/or any other type of data storage device. The data storage device 138 in some non-limiting embodiments includes a redundant array of independent disks (RAID) array. In other non-limiting embodiments, the data storage device(s) provide a shared data store accessible by two or more hosts in a cluster. For example, the data storage device may include a hard disk, a redundant array of independent disks (RAID), a flash memory drive, a storage area network (SAN), or other data storage device. In still other embodiments, the data storage device 138 includes a database, such as, but not limited to, the database 224 in FIG. 2 below.

The data storage device 138, in the example shown in FIG. 1, is included within the computing device 102, attached to the computing device, plugged into the computing device, or otherwise associated with the computing device 102. In other embodiments, the data storage device 138 includes a remote data storage accessed by the computing device via the network 112, such as a remote data storage device, a data storage in a remote data center, or a cloud storage.

The memory 108, in some embodiments, stores one or more computer-executable components, such as, but not limited to, the cluster detection manager 130. In some embodiments, the cluster detection manager 130 obtains the image(s) 122 of a recognized area associated with a retail facility. The image(s) 122 include multiple clusters of items of interest associated with multiple different object types. For example, the image can include a portion of an item storage structure, a freezer or refrigerated display door, location tag, price tag, clusters of items, boxes, jars, cans, bottles, and/or empty spaces. The cluster detection manager 130 analyzes the image using a multi-object cluster detection model that is trained on the training data 128. The multi-object cluster detection model is trained to recognize the plurality of clusters of different object types using image data associated with the image(s) 122.

The cluster detection manager 130 identifies one or more cluster(s) 124 of item(s) 126 of interest associated with the plurality of object types 134 within the image(s) 122 and an object type for each identified cluster. The cluster detection manager 130 generates indicator(s) 148 within the image data associated with the cluster(s) 158. The indicator(s) 148 include a different indicator for each different object type. The cluster detection manager 130 generates a labeled image 170 of the location 160 within the field of view (FOV) of the image(s) 122. The labeled image 170 is a single image or a cropped portion of the image from the image(s) 122 with the overlay 150 superimposed over it. The labeled image 170 includes the indicator(s) 148 within the overlay 150.

In some embodiments, the labeled image 170 includes text indicators, such as label(s) identifying the type of each instance of each item or cluster of items in the image. In some embodiments, the text included in the label(s) are names or identifiers associated with each class or type of object, such as, but not limited to, a cluster of items of a same item type, a price tag, a location tag, a “pallet” label, a “horizontal bar” label, a “vertical bar” label, a pallet “wood” base label, a “void” empty space label, etc. The text can optionally include a score or ranking indicating a confidence (confidence score). The confidence score optionally indicates a degree of confidence that a cluster of interest has been detected and identified by a cluster indicator in the indicator(s) 148. The labeled image 170 is stored in the data storage device 138, transmitted to the cloud server 118 and/or presented to the user via the user interface device 110.

Thus, the system can include non-text indicators and/or text indicators, such as a label. The indicators can include a name, abbreviation, alphanumeric code, identification number, or description of the object type.

In other embodiments, the indicators are implemented as color-coded indicators, such as, different colored bounding boxes. A color-coded bounding box is any shape of bounding box, such as a color-coded rectangular bounding box placed around an object, a color-coded circle placed around an object, a color-coded triangle placed around an object, etc. In this example, different clusters of objects can be enclosed within a different shaped bounding box. The different shaped bounding boxes can include color-coding or no color-coding as the shape of each bounding box identifies the object class.

The indicators can also optionally include a combination of color-coded non-text indicators as well as textual indicators, such as placing a color-coded bounding box around an object and adding a text label to further identify the object.

However, the embodiments are not limited to textual indicators and color-coded bounding boxes. The indicators, in other embodiments, can include color-coded arrows pointing to objects of interest, color-coded lines placed under or above an object, highlighting/shading of objects in different colors to indicate different clusters of items, or any other type of indicator which can be superimposed over an image of one or more objects.

The cluster detection manager 130 in other embodiments, maps the clusters of items to the recognized location 160 within an item-to-location mapping table. The table may be stored on the data storage device 138 and/or stored on the cloud server 118.

The system 100 provides a scalable, high performance multi-object cluster detection model that detects multiple different types of objects and clusters of items of interest, as well as an item count of each type of item and number of clusters detected in each image with high accuracy. The model is a combined multi-object cluster detection model trained to detect two or more different types of objects in two or more clusters based on attributes of the items, such as item size, color, and/or shape of the items in each cluster. The system 100 detects clusters of same/similar sized and shaped objects from input images generated by one or more image capture devices, such as an autonomous robotic image capture device.

In this example, the cluster detection manager 130 performs the functions of multiple different object detection models combined into one single, unified model (pallet and pallet tag; doors, groups of items, vertical steel bar; horizontal steel bar; pallet wood; shelf, location tag, freezer, price tag, product, and void spaces). However, the embodiments are not limited to detecting these different types of objects. The cluster detection manager 130 can be trained to detect any number of different types of objects/items.

In this example, the input images are analyzed and labeled with bounding boxes for each different cluster of items on a storage unit/storage structure using the labeling platform. The system detects clusters of objects and annotates the image(s) using polygon bounding boxes during image analysis. In this manner, the cluster detection manager 130 detects clusters objects, object classes, number of clusters, number of items in each cluster, and/or types of objects of interest in an image with improved accuracy.

In some embodiments, the labeled image 170 results are output to an inventory management system for use in updating inventory data and/or pallet location data. The results can optionally also be used to create and/or update a planogram, restock shelves, identify item outs for restocking, update product order information, identify void spaces associated with item outs or placement of new items, etc. The cluster detection manager can be trained to identify different clusters of different types of objects using labeled training data. The labeled training data includes labeled images having one or more clusters of items labeled within the training data images.

The cluster detection manager 130, in some embodiments, obtains an image of an item storage structure captured by an image capture device using a multi-object cluster detection model. The cluster detection manager 130 detects a plurality of clusters of interest associated with a plurality of object types within the image, the plurality of clusters of interest comprising a first cluster of items associated with a first object type and a second cluster of items associated with a second object type. The cluster detection manager 130 generates a labeled image comprising a plurality of indicators within an overlay associated with the image. The plurality of indicators includes a first cluster indicator associated with the first cluster of items of interest within the image and a second cluster indicator associated with the second cluster of items of interest within the image. The cluster detection manager 130 identifies a number of unique clusters of items associated with a location within a retail facility corresponding to the plurality of clusters of interest detected within the labeled image using the plurality of indicators. The cluster detection manager 130 determines whether the identified number of unique clusters of items equals an expected number of unique clusters of items indicated in inventory data. In one example, the identified number of clusters detected in the image is compared with an expected number of clusters which should be present at the location 160 based on inventory data 146, such as item assortment and/or planogram data. If the identified number of unique clusters of items exceeds the expected number of unique clusters of items, the cluster detection manager 130 generates one or more incorrectly placed items notification(s) indicating at least one incorrectly placed item at the location. If the expected number of unique clusters of items exceeds the identified number of unique clusters of items, the cluster detection manager 130 generates one or more item out notification(s) indicating at least one out-of-stock item. The notification(s) 152, including the item out notification(s) and/or the incorrectly placed items notification(s) are presented to a user via a user interface associated with the computing device 102 and/or the user device 116. In some embodiments, the notification(s) 152 include an alert to a user to restock an item which is out of stock. In other embodiments, the notification(s) include an alert to a user to remove a misplaced item from the shelf.

The cluster detection manager 130 in this example is implemented on the computing device 102. However, the embodiments are not limited to implementing the cluster detection manager on a computing device. In other embodiments, the cluster detection manager is implemented on a cloud server, such as, but not limited to, the cloud server 118.

In other embodiments, the cluster detection manager 130 is able to detect partial clusters. A partial cluster is a cluster of items which is only partially visible within an image. For example, if a cluster of items which is located at or near a corner of a shelf or other item display may only be partially visible within the images due to the limited camera angles and/or obstructions, such as portions of the item storage structure or other fixtures blocking the full view of the cluster.

In other embodiments, the cluster detection manager 130 detects multi-item clusters containing two or more items having the same or similar color, shape, and/or size. A multi-item cluster is a cluster of multiple instances of a single type of item. For example, a bottle of brand “X” organic apple juice is a single type of item. A cluster of two or more bottles of the brand “X” organic apple juice having a red cap and a red apple on the label is a multi-item cluster. However, a single instance of the brand “X” organic apple juice is a single-item which is not a cluster, or it is optionally identified as a single-item cluster. Likewise, in the above example, if the system detects two or more bottles of a brand “Z” apple juice with a green lid and a different size than the brand “X” apple juice, those items are identified as a different, unique cluster of items. The system is able to identify the distinct clusters based on the size, shape, and/or colors associated with the items. The system is not limited to identifying different items based on brand names, product names, item ID, or other specific item identifications. However, the system can optionally use item brand names, product names, item ID or other specific item identifications to assist with cluster identification.

In some embodiments, the multi-item clusters are identified on the shelf via the ML model(s) analysis of image(s) of the items. Each multi-item cluster is used to increment a unique product type counter. The unique product type counter is used to verify that the correct number of unique products (items) are present on the shelf. This enables automatic verification of shelf stocking and item assortment for inventory updating and restocking. In these examples, a single item is not detected or recognized as a cluster. Instead, if the system recognizes a single item, it is assumed to be an out-of-stock item that needs to be restocked. However, the embodiments are not limited to multi-item clusters. In other embodiments, the system optionally recognizes single items as a single-item cluster. A single-item cluster is optionally counted as a low-stock item which may require restocking or manual verification to ensure sufficient instances of the item are available on the shelf.

FIG. 2 is an exemplary block diagram illustrating a retail facility 200 having a plurality of clusters 202 associated with at least a portion of an item storage structure 204. In this example, the image capture device(s) 206 are mounted to one or more robotic device(s) 208 which roam around the retail facility 200 generating image(s) 212 of items on one or more item storage structure(s) 204. The retail facility 200 is a facility or area within a retail environment. The retail facility 200, in this example, is a store. The image capture device(s) 206 includes one or more devices for generating digital images, such as, but not limited to, the one or more image capture device(s) 120 in FIG. 1. In this example, the image capture device(s) 206 generate color images.

The image capture device 210 is an image capture device for generating one or more image(s) 212. The image capture device 210 can be implemented as a handheld camera and/or a camera mounted to a fixture, such as a wall, support pillar, archway, metal truss, ceiling member, shelf, or any other device or fixture in the retail facility 200. In this example, only a single mounted or handheld image capture device is shown. However, the embodiments are not limited to a single handheld or mounted image capture device. In other examples, there may be no handheld image capture devices and/or no mounted cameras. In still other examples, the system can include two or more mounted or handheld image capture devices.

The image(s) 212 includes one or more images of one or more clusters of items in the plurality of clusters 202, such as, but not limited to, the image(s) 122 in FIG. 1. An item storage structure in the one or more item storage structure(s) 204 is a structure for storing one or more different types of items. A different type of item can include different sizes and/or different varieties of a given item. For example, a sugar-free brand of ketchup and an organic brand of ketchup are different varieties of ketchup. In this example, the regular ketchup, sugar-free ketchup, and organic ketchup are classified as three different types of items/objects.

The clusters of items detected by the system may be stored on the item storage structure, hanging from a hook or peg on the item storage structure, placed underneath the storage structure, and/or adjacent to the storage structure. The item storage structure includes pallet bins, shelving, display cabinets, temperature-controlled display cases (freezer/refrigerator cases), end-cap displays, or any other storage structures.

In some non-limiting examples, an item storage structure includes storage members, such as horizontal bar(s) and/or vertical bar(s). The horizontal and vertical bars in this example are made of steel. The item storage structure(s) 204 optionally includes void space(s) 214 and/or location tag(s) 216. A void space is an empty space or partially empty space on the storage structure, under the storage structure or adjacent to the storage structure in which another pallet could be placed. A location tag is a tag or label attached to a portion of an item storage structure or other fixture. A location tag includes a location ID identifying a location or other area within the retail facility. The location ID optionally includes an identifier associated with an aisle, shelf, and/or portion (section or segment) of a shelf.

In this example, the image(s) 212 are transmitted from the image capture device(s) 206 and/or the image capture device 210 to the cloud server 118 hosting the cluster detection manager 130. The cluster detection manager 130 analyzes the image(s) 212 to detect multiple clusters of instances of objects from multiple different object classes and/or different object types. The cluster detection manager 130 generates labeled image data 218 associated with a labelled image 220. The labeled image data 218 includes indicators identifying each unique cluster of items identified in each image. The identified clusters, in some embodiments, are mapped to the location of the item storage structure(s) 204 in a mapping table 222 stored on a database, such as, but not limited to, an inventory database 224. The mapping table 222 and/or the labeled image data 218 are optionally stored on one or more data storage devices, such as, but not limited to, the data storage device 138 in FIG. 1.

The inventory database 224 is a database for storing inventory data 226. The inventory data 226 includes inventory data, such as, but not limited to, item assortment data, planogram data, an expected number of clusters of items assigned to each location or item storage structure, etc. The inventory database can also include item-specific data, such as the name of each item in the inventory, an image of each item, size, shape, color of product packaging, pricing information, etc.

Each item storage structure, in this example, includes a plurality of items 230, such as the one or more item(s) 234 in a first cluster 232 and/or one or more item(s) 238 in a second cluster 236. The cluster detection manager 130 performs object detection and recognition to identify each cluster of items in one or more of the image(s) 212. The image data is labeled with an indicator, such as a bounding box, identifying each cluster identified in each image.

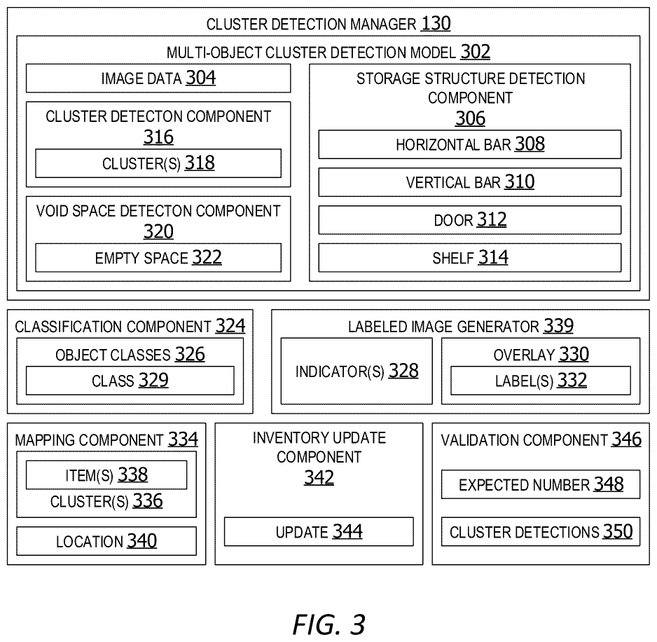

Referring now to FIG. 3, an exemplary block diagram illustrating a cluster detection manager for detecting clusters of items of interest using a unified CV model is shown. The cluster detection manager 130 includes a multi-object cluster detection model 302. The multi-object cluster detection model 302 is a trained ML model, such as, but not limited to, the one or more ML model(s) 136 in FIG. 1. The multi-object cluster detection model 302 is trained to identify clusters of multiple different types of objects in images.

A storage structure detection component 306 includes one or more algorithms for detecting and/or recognizing objects, such as, but not limited to, a horizontal bar 308, a vertical bar 310, a display case door 312, and/or a shelf 314. The horizontal bar and vertical bar can be composed of steel.

A cluster detection component 316 analyzes image data 304 to detect and recognize one or more cluster(s) 318 of multiple instances of an item. A void space detection component 320 identifies empty space 322, including partial empty spaces, in image data 304.

The cluster detection manager 130 optionally includes a classification component 324 that classifies each object detected in the image data 304. The object classes 326 can include, without limitation, different types of items (products), a pallet-related object class, a pallet storage structure-related object class, and/or an available space object class. The classification component generates indicators 328 for each class 329 and/or each type of object. Each class can include one or more types of objects. For example, the pallet-related object class can include a pallet type of object, a pallet tag type of object, and/or a pallet wood base type of object. The pallet storage structure-related object class can include a horizontal bar type of object and/or a vertical bar type of object. The available space object class can include a partial-empty type of object and/or a void (empty) type of object.

The identified clusters of items are enclosed in bounding boxes in the image data. The bounding boxes are optionally color-coded based on the class and/or type for each item. For example, horizontal bars can be enclosed in yellow bounding boxes while vertical bars are enclosed in orange bounding boxes. Thus, each type of object is assigned a different color for the bounding boxes enclosing the detected objects.

In other embodiments, the cluster detection manager 130 adds label(s) to the image data. The one or more label(s) include text, such as alphanumeric text, identifying the type of each object enclosed in a bounding box. For example, a pallet wood base can be labeled with a text label, such as, but not limited to, the word “wood” or “base.” In another example, the pallet tag objects can be labeled with a text label including the word “tag.” The label(s) 332 identify the clusters identified by the cluster detections 350. Cluster detections 350 refers to the results of the CV item detections and recognitions performed by the cluster detection manager. Items identified by the cluster detection manager in the cluster detections 350 are labeled within the image data as an overlay of indicators, in some embodiments.

Optical character recognition (OCR) is performed to read text on the detected price tags, location tags and/or pallet tags. The OCR detects item and/or pallet information, such as an item price, item identifier (ID), pallet ID, location ID, and/or date a tag is created. The pallet ID and/or item ID is used to retrieve data associated with the pallet and/or the items associated with each pallet tag. In one example, the system identifies a pallet ID from a pallet tag on a pallet using OCR and maps a set of items on the pallet to the location of the pallet in an item-to-location mapping table.

In some embodiments, a labeled image generator 339 generates an overlay 330 including label(s) 332 labelling the type of each object identified in the image data. The label(s) 332 are indicators included in the overlay 330. The image data 304 including the overlay 330 is a labeled image.

In other embodiments, a mapping component 334 maps identified clusters 336 of item(s) 338 to a recognized location 340 associated with the location of the item storage structure and/or the location of the image capture device generating the image data 304. The items are mapped to the location in a database, such as, but not limited to, the inventory database 224 in FIG. 2.

In still other embodiments, an inventory update component 342 performs an update 344 to inventory data in response to identification of one or more clusters in a given location. A validation component 346 optionally uses an expected number 348 of clusters for a given location to determine whether there are any item outs and/or misplaced items at a given location. The validation component, in other examples, compares the detected number of clusters with the expected number of clusters for a given location to confirm item identification of at least one item in inventory data. In other words, if the detected number of clusters matches the expected number of clusters (number of different types of items assigned to a given location), the current inventory data is validated as correct. In some embodiments, the validation is an item-to-location validation which ensures the detected clusters of items correspond with the assigned location of individual items on the shelf. In other words, item level detections are used to identify items, and the cluster detections 350 are used to validate that the number of unique types of items detected using CV matches the number of unique types of items assigned to the current location.

FIG. 4 is an exemplary block diagram illustrating labeled image data 400. In this example, the labeled image data 400 includes image data associated with a portion of an item storage structure 402 containing a cluster 406 of item(s) 408 labeled with a first indicator 404 and a cluster 412 of item(s) 414 labeled with a second indicator 410. Each unique cluster of items is identified with a different indicator. In this example, the indicator 404 is a bounding box enclosing the cluster 406 of item(s) 408 and the indicator 410 is another bounding box enclosing the cluster 412 of item(s) 414.

FIG. 5 is an exemplary block diagram illustrating labeled image data 500 including a plurality of indicators associated with a plurality of clusters of items on an item storage structure 502. In this example, each cluster is enclosed by a bounding box indicator, such as, but not limited to, the cluster 504, cluster 506, cluster 508, cluster 510, cluster 512, cluster 514, and/or the cluster 516. In this example, each cluster is indicated by a pair of brackets. However, in other examples, the indicator appears as a bounding box. In still other examples, each cluster indicator is a circle, a rectangle, a square, a pentagon, or any other shaped indicator. The labeled image data 500 in this example also includes a void space 518 and a void space 520. The void spaces are optionally also identified via an indicator, such as, but not limited to, a bounding box, arrow, pair of brackets, or any other type of indicator.

In some embodiments, the indicators are color-coded. For example, the cluster indicators are one or more colors while the void space indicators are a different color from the cluster indicators. This enables a user to identify and distinguish clusters from other objects of interest, such as item storage structure members, void spaces, display case doors, or other objects of interest quickly and easily.

The embodiments are not limited to the labeled clusters of items or the configuration of the labeled clusters of items in the labeled image data 500. In other embodiments, the labeled image includes more clusters or fewer clusters than is shown in FIG. 5. Likewise, the labeled image data can include clusters of different types of items than the types of items shown in FIG. 5. For example, instead of grocery items, as shown in FIG. 5, the clusters of items can include tools, shoes, apparel, pet supplies, office supplies, or any other type of items.

The system identifies items that are exactly the same which are placed in close proximity to each other. In this manner, the system detects a whole cluster of items. The system segregates multiple clusters into distinct groups using the indicators to determine how many unique products (types of items) are present in a given location.

The system distinguishes different types of items based on the size, shape, and color of the items. For example, identical jars of peanut butter having different colored lids and/or different colored labels are distinguished as different types of items based on the different colors of the lids and/or labels. Likewise, jars of pickles which are packaged in different sizes of jars can be distinguished based on the sizes of the jars. A stack of small jars of pickles are identified as a different cluster of items than a stack of medium sized jars or a stack of large sized jars of the same brand of pickles. In yet another example, if three bottles of honey in close proximity to each other are shaped like a bear and another group of honey bottles are cylindrical, the system identifies the bear-shaped bottles as one unique cluster of items and the cylindrical shaped bottles of honey as a different, unique cluster of items.

Proximity is also used to identify different clusters of items. For example, if two boxes of baking soda have the same size, shape and/or color of packaging and are located within a quarter of an inch from each other, these two boxes are identified as being part of the same cluster. If another box of a larger size is located several inches away from any other boxes on the shelf, the system identifies the item as a separate cluster or possibly as a misplaced item if the lone item does not match an image or description of any item assigned to the item storage structure.

FIG. 6 is an exemplary flow chart illustrating operation of the computing device to detect clusters of items in an image of an item storage structure. The process 600 shown in FIG. 6 is performed by a cluster detection manager component, executing on a computing device, such as the computing device 102 or the user device 116 in FIG. 1.

The process begins by obtaining one or more image(s) of an item storage structure at 602. The image(s) include color images generated by an image capture device, such as, but not limited to, the image(s) 122 in FIG. 1. The cluster detection manager detects one or more cluster(s) of items in the image(s) at 604. The cluster(s) include groups of items of interest, such as, but not limited to, the cluster(s) 158 in FIG. 1. The cluster(s) are detected and recognized by a trained CV model, such as, but not limited to, a trained unified CV model in the one or more ML model(s) 136 in FIG. 1. The cluster detection manager generates labeled image(s) at 606. A labeled image is an image having an overlay including one or more cluster indicators, such as, but not limited to, the indicator(s) 148 in FIG. 1. The cluster detection manager identifies the number of clusters in the image(s) at 608. Inventory data is updated using the cluster detection data at 610. The inventory data is updated to indicate that the identified number of clusters is equal to the expected number of cluster, the number of identified clusters to too low indicating item-outs, and/or the number of clusters identified in the image(s) is higher than expected suggesting one or more misplaced items at the location of the detected clusters. The process terminates thereafter.

While the operations illustrated in FIG. 6 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 6.

FIG. 7 is an exemplary flow chart illustrating operation of the computing device to generate labeled image data including cluster indicators. The process 700 shown in FIG. 7 is performed by a cluster detection manager component, executing on a computing device, such as the computing device 102 or the user device 116 in FIG. 1.

The process begins by analyzing image data at 702. The image data is data associated with one or more images, such as, but not limited to, the image(s) 122 in FIG. 1. A determination is made whether a cluster of items of interest is detected in the image data at 704. If no cluster is detected, the process terminates thereafter. If a cluster is detected, a cluster indicator is added to the image data at 706. The cluster indicator is an indicator identifying a detected cluster of items, such as a bounding box or other color indicator. A determination is made whether a next cluster is detected at 708. If a cluster is detected, another indicator is added to the image data at 706. The process iteratively executes operations 706 through 708 until a cluster indicator has been added to the image data for each detected cluster of items. When no additional clusters are detected, the process stores the labeled image data at 710. The labeled image data is stored in a database or other data storage device, such as, but not limited to, the data storage device 138. The process terminates thereafter.

While the operations illustrated in FIG. 7 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 7.

FIG. 8 is an exemplary flow chart illustrating operation of the computing device to identify incorrectly placed items and out-of-stock items using labeled image data. The process 800 shown in FIG. 8 is performed by a cluster detection manager component, executing on a computing device, such as the computing device 102 or the user device 116 in FIG. 1.

The process analyzes labeled image data at 802. The labeled image data is image data including one or more cluster indicators in an overlay identifying detected clusters of items of interest. The cluster detection manager calculates the number of unique clusters detected in the labeled image data at 804. The cluster detection manager identifies the location of the clusters at 806. The location is identified using CV item recognition of a location tag on the item storage structure and/or optical character recognition (OCR) of text on a location tag on the item storage structure. The cluster detection manager determines an expected number of unique clusters of items for the location at 808. A determination is made whether the expected number of unique clusters of items for the location equals the detected number of unique clusters at 810. If they are equal, the process terminates thereafter.

If the expected number of clusters is not equal to the detected number of clusters, the cluster detection manager determines whether the detected number of clusters exceeds the expected number of clusters at 812. If yes, misplaced items are identified at 816. A misplaced item is an object which is not assigned to the current location of the item. A misplaced item notification is generated at 818. The notification is output to a user via a UI at 820. The process terminates thereafter.

If the detected number of clusters does not exceed the expected number of clusters at 812, the cluster detection manager identifies out-of-stock items at the location at 814. An item-out-of-stock notification (item out notification) is generated at 818. The item-out-of-stock notification is output to a user via a UI at 820. The process terminates thereafter.

While the operations illustrated in FIG. 8 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 8.

FIG. 9 is an exemplary flow chart illustrating operation of the computing device to map clusters of items to locations within a retail facility. The process 900 shown in FIG. 9 is performed by a cluster detection manager component, executing on a computing device, such as the computing device 102 or the user device 116 in FIG. 1.

The process begins by receiving image data at 902. The cluster detection manager labels clusters of interest at 904. Clusters are mapped to a location within a mapping table at 906. The labeled image data is stored at 908. In some embodiments, the labeled image data is stored in a data storage device, such as, but not limited to, the data storage device 138 in FIG. 1. A determination is made whether to output the labeled image data at 910. If a determination is made to output the labeled image data, the labeled image data is presented to a user via a UI at 912. The process terminates thereafter.

While the operations illustrated in FIG. 9 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 9.

FIG. 10 is an exemplary flow chart illustrating operation of the computing device to validate inventory data using cluster detection results. The process 1000 shown in FIG. 10 is performed by a cluster detection manager component, executing on a computing device, such as the computing device 102 or the user device 116 in FIG. 1.

The process begins by detecting a cluster of items of interest at 1002. The cluster is labeled with an indicator at 1004. A determination is made whether a new cluster is detected at 1006. If yes, the cluster is labeled with an indicator. The process iteratively executes operations 1004 and 1006 until all clusters are detected and labeled with an indicator. The number of clusters is calculated at 1008. Inventory data is validated using the calculated number of clusters at 1010. The inventory data optionally includes item identification of at least one item assigned to a given location. A determination is made whether the inventory data is valid at 1012. If not, a notification is generated at 1014. The process terminates thereafter.

While the operations illustrated in FIG. 10 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 10.

### Additional Examples

In some embodiments, the system includes a unified multi-object cluster detection model (trained CV model) trained to recognize groups (clusters) of different types of products in an image generated by a robotic device using CV analysis and optical character recognition. The system is able to detect and recognize different types and varieties of products on shelves arranged in groups/clusters based on color, shape and size of the products and/or product packaging. The model identifies the location of the clusters, missing clusters/void (empty) spaces, number of clusters and number of items in each cluster. The model recognizes other objects in proximity to the product clusters, such as shelves, display cases, shopping carts, location tags, price tags, etc. The location of the clusters is determined using location data provided by the robotic device as well as other objects detected by the CV analysis, such as shelving and location tags.

In other embodiments, a multi-object cluster detection model (trained CV model) detects and recognizes clusters of items (products) on an item display in a retail facility. The system detects and recognizes a plurality of clusters (groups) of items (objects) of different types and varieties using image(s) of a portion of an item display area within a retail facility. The system determines the number of different clusters of items on a shelf using CV analysis of images of the shelf. The system determines the number of items in each cluster of different types of items on a shelf using CV analysis of images of the shelf captured by a robotic device.

In still other embodiments, the system detects and recognizes items on shelves, void (empty) spaces, shelving members (vertical steel bars and horizontal steel bars), temperature-controlled display case doors (freezers and refrigerator doors), location tags, and item ID tags present in the images. The system uses cluster detections for mapping correct location of clusters of items in a retail facility, predicting out of stock items, alerting associates of out of stock items/trigger restocking tasks, identify misplaced items, generate exceptions for missing/misplaced items in store and update inventory automatically. A misplaced item is an item that is incorrectly placed and/or identified at a location to which the item is not assigned (unassigned location). The images captured by a robotic device are labelled with indicators to identify each detected cluster of items using different colored/shaped indicators, such as bounding boxes overlaid on the image of the item clusters.

The system, in other embodiments, provides CV based inventory management methods to detect various entities of interest grouped in clusters using an input image of the items. The cluster detection manager is a highly scalable, high performance single object detection algorithm that can detect multiple entities at once from the image with high accuracy. There are different variety of entities like vertical steel bar, horizontal steel bar, freezer door, price tag, pallet woods, pallet, clusters, cart, obstructions, freezer door, location tag, location tags etc. are present in the images captured from floor area by mobile robotic devices, all of which are useful for mapping correct location of items in a store, predicting out of stock items, reading price tags, triggering out-of-stock item notifications, etc.

In other embodiments, the system provides a fast, lightweight multi-class object detection model according to our needs and produce a high accuracy multi-object cluster detection model that can detect groups of items of interest from an input image. The system uses a collection of images of the store floor (sales) area and/or reserve area from multiple stores ensuring good representation of all items and other objects of interest covering various possible angles and lighting conditions of each object for training the ML model.

In some embodiments, the system utilizes colored images in these examples. The images are labelled for each cluster of items using polygon bounding boxes on our inhouse labelling platform. The system converts them to rectangles (by taking min and max across all polygon vertices). Then converts the coordinates of the obtained rectangle into our downstream model format.

In some embodiments, the system collects images of store sales areas from multiple stores ensuring good representation of all clusters of objects of interest covering various possible angles and lighting conditions of each object/type of object. The images are labelled for each object class using polygon bounding boxes on our inhouse labelling platform. The bounding boxes are converted to rectangles (by taking minimum and maximum across all polygon vertices). Then converted the coordinates of the obtained rectangle into our downstream model format.

The multi-object cluster detection model includes a clustering algorithm which works using multiple heterogenous signals like proximity, visual and textual similarity of items, size, shape, color, and/or recognition model predictions etc. The cluster detection model detects groups of items of various sizes, such as clusters of very small items.

The system, in other embodiments, detects void spaces. The void space detection using item storage structure detection and a depth model for estimating the depth of items detected within an image. The system also includes a low stock alert (item out notification) to help improve restocking and reduce errors in inventory data. A depth model is able to calculate a depth measurement or depth value indicating whether an item in an image is in the foreground or background. The depth model determines the depth (how far away) is each item in the image.

For example, one item may be closer to the image capture device and/or the edge of a shelf than another item. Likewise, a depth value can be used to determine if there is a void space on the shelf even where an item located behind the shelf is visible through the gap in the items that are actually present on the shelf. In this manner, the system does not confuse items located behind the shelf with items located on the shelf based on the depth value. In some examples, depth values within a predetermined range are associated with items on the shelf while items having a greater/higher depth value or a depth value outside the acceptable predetermined range are designated as items located behind the shelf, behind the shelf, or otherwise located farther away than other items in a given cluster.

The system is a high performance and scalable model architecture for detecting incorrect clustering, incorrect bounding box detections for price tags and location tags, with different style, layout, and font. The system reduces the inference time compared to individual models for each class. Better accuracy is enabled due to ensemble learning. The model uses other class detections and leverages inter-class dependencies which results in reduction of false positive rates compared to individual models.

In some embodiments, the cluster detection manager is implemented on an item recognition as a service (IRAS) computer vision platform that is capable of recognizing a plurality of different types of objects, such as pallets, individual items, pallet wooden bases, pallet tags, item ID tags, horizontal bars, vertical bars, freezer doors, price tags, location ID tags, and void (empty) spaces.

In other embodiments, the system provides a uniform cluster detection model that combines multiple item detection and recognition models into one single model, such as, but not limited to, a pallet and tag detection model, a vertical steel bar detection model, a horizontal steel bar detection model, a pallet wood detection model, a freezer door detection model, a location tag detection model, and an empty space (void) detection model for pallet storage area (reserve area) combined detection.

In an example scenario, the system obtains an image of an item storage area. The cluster detection model analyzes the image. The model identifies all clusters of items and empty (void) spaces visible within the image. The model adds indicators to the image as an overlay. The indicators include color-coded bounding boxes surrounding the clusters and/or the empty spaces in the image. The model optionally also adds text labels within the overlay identifying the clusters and empty spaces shown in the image. The system outputs a labeled image having the overlay identifying each multi-item cluster and/or each single-item cluster. The number of clusters is used to identify the number of unique item types on a shelf or other item storage structure. In an example scenario, if a shelf is assigned for display of three types of ketchup and four types of barbeque sauce, the total number of unique products on the shelf is seven. If the system detects seven multi-item clusters, the number of identified clusters is equal to the expected number of unique items on the shelf. If the system only detects five multi-item clusters and one single-item cluster, the system is able to determine that at least one product is out-of-stock and at least one other product is low stock (single instance on the shelf) and requiring replenishment. If the system detects seven multi-item clusters and two single-item clusters, the system is able to determine if there are potentially two misplaced items on the shelf which may require removal or relocation. The system is able to do this without identifying specific item names, item ID, or other specific identification of individual items. This enables determination of item outs and misplaced items and/or verification that the correct number of products are in-stock on the shelf while minimizing resource utilization where processor, memory and network bandwidth usage associated with identifying specific items is rendered unnecessary.

In other examples, the system uses cluster detections to verify specific item identifications performed by other CV models identifying specific items on the shelf. In other words, if another CV model identifies three specific varieties of ketchup on the shelf and identifies four distinct varieties of barbeque sauce on the same shelf, the system can verify this using the cluster detections confirming that seven unique clusters of items are present on the shelf.

In some embodiments, the system collects images from an area of interest, such as a sales floor area, from multiple stores for training the model. This ensures good representation of all objects of interest. The images are labeled with bounding boxes for each object class and/or object type using an inhouse labelling platform. The cluster detection model is trained using the labeled training data to produce a small, lightweight, and fast cluster detection model.

In some embodiments, the model is a pre-trained deep learning model with a convolutional neural network (CNN). In this example, the model is a you only look once (YOLO) deep learning model. The object detection model is trained on the custom labeled dataset to achieve the desired accuracy across multiple different object classes and types of objects.

The system provides a high performance and scalable model architecture for detecting multi-item clusters, void spaces, and item storage structure members. The model is smaller, faster, and more accurate than using two or more individual models to detect the different types of objects. The system uses rich datasets, including a mixture of high quality reserve steel components. The model is able to more accurately manage difficult situations, such as incorrect bounding box detections for pallet tags with different fonts, layout, and style.

In other embodiments, the cluster detection model is a very efficient combined model that reduces the inference time by five times compared to individual models for each type of object. This enables better accuracy due to ensemble learning reduction in false positive rate by nine percent compared to individual models.

In another example scenario, a cluster detection model is trained using labeled training data including labeled objects of interest. The system analyzes a selected image from the plurality of images using the trained cluster detection model. A plurality of clusters of interest is identified within the selected image, by the trained cluster detection model. Each cluster of interest is labeled within the selected image. The system generates a labeled image that includes the identified objects and labels associated with the identified objects.

Alternatively, or in addition to the other examples described herein, examples include any combination of the following:
determine whether the identified number of unique clusters of items equals an expected number of unique clusters of items indicated in inventory data;
responsive to the identified number of unique clusters of items exceeding the expected number of unique clusters of items, generate a misplaced items notification indicating at least one misplaced item at the location;
responsive to the expected number of unique clusters of items exceeding the identified number of unique clusters of items, generate an item out notification indicating at least one out-of-stock item;
validate inventory data, including item identification of at least one item assigned to a given location, associated with the location within the retail facility using the identified number of unique clusters;
Confirm an item identification of at least one item detected at a given location using the identified number of unique clusters, wherein the number of unique clusters identified is compared with an expected number of unique items at the location to confirm previous item identifications at the given location are correct;
analyze the image using a set of parameters for distinguishing unique items, the set of parameters comprising size, shape, color, and proximity;
detect a first cluster comprising at least one instance of a first type of item and a second cluster comprising at least one instance of a second type of item, wherein the first type of item has at least one of a different size, shape, and color than the second type of item;
detect, by the multi-object cluster detection model, a cluster of items comprising at least one instance of an item, wherein each instance of an item in the cluster is located within a predetermined proximity to at least one other item having the similar size, shape, and color;
identify a location tag on at least a portion of an item storage structure associated with the detected cluster of items;
determine the location of the detected cluster of items using the location tag;
update an inventory database with the location of the detected cluster of items;
map a current location of each unique cluster of items in the plurality of clusters of interest to a location of a portion of an item storage structure in an inventory database using image data associated with the labeled image;
detect multi-item clusters and increment a multi-item cluster counter for calculating a number of unique item types and/or varieties of items currently available on the shelf or other item storage structure;
compare the number of clusters detected in the image(s) with an expected number of unique items assigned for display on the item storage structure, wherein the number of clusters includes the number of multi-item clusters;
wherein the number of clusters detected in the image(s) excludes single-item clusters having only a single instance of an item visible in the image(s);
identifying a number of unique types of items currently present on an item storage structure using the number of identified multi-item clusters visible in one or more images without identifying a name or item ID of any of the items visible within the images; and
identify single-item clusters on a shelf or other item storage structure and identify single-item clusters as items that are low stock for replenishment.

At least a portion of the functionality of the various elements in FIG. 1, FIG. 2, and FIG. 3 can be performed by other elements in FIG. 1, FIG. 2, and FIG. 3, or an entity (e.g., processor 106, web service, server, application program, computing device, etc.) not shown in FIG. 1, FIG. 2, and FIG. 3.

In some embodiments, the operations illustrated in FIG. 6, FIG. 7, FIG. 8, FIG. 9, and FIG. 10 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other embodiments, a computer readable medium having instructions recorded thereon which when executed by a computer device cause the computer device to cooperate in performing a method of multi-object cluster detection with improved accuracy, the method comprising obtaining, from an image capture device, an image of an item storage structure using a multi-object cluster detection model; detecting a plurality of clusters of interest associated with a plurality of object types within the image, the plurality of clusters of interest comprising a first cluster of items associated with a first object type and a second cluster of items associated with a second object type; generating a labeled image comprising a plurality of indicators within an overlay associated with the image, the plurality of indicators comprising a first cluster indicator associated with the first cluster of items of interest within the image and a second cluster indicator associated with the second cluster of items of interest within the image; and identifying a number of unique clusters of items associated with a location within a retail facility corresponding to the plurality of clusters of interest detected within the labeled image using the plurality of indicators.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some embodiments, to a wireless local area network using high frequency radio signals for the transmission of data. The term “BLUETOOTH®” as used herein refers, in some embodiments, to a wireless technology standard for exchanging data over short distances using short wavelength radio transmission. The term “NFC” as used herein refers, in some embodiments, to a short-range high frequency wireless communication technology for the exchange of data over short distances.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for multi-object cluster detection with improved accuracy. For example, the elements illustrated in FIG. 1, FIG. 2, and FIG. 3, such as when encoded to perform the operations illustrated in FIG. 6, FIG. 7, FIG. 8, FIG. 9, and FIG. 10, constitute exemplary means for obtaining, from an image capture device, an image of an item storage structure using a multi-object cluster detection model; exemplary means for detecting a plurality of clusters of interest associated with a plurality of object types within the image, the plurality of clusters of interest comprising a first cluster of items associated with a first object type and a second cluster of items associated with a second object type; exemplary means for generating a labeled image comprising a plurality of indicators within an overlay associated with the image, the plurality of indicators comprising a first cluster indicator associated with the first cluster of items of interest within the image and a second cluster indicator associated with the second cluster of items of interest within the image; and exemplary means for identifying a number of unique clusters of items associated with a location within a retail facility corresponding to the plurality of clusters of interest detected within the labeled image using the plurality of indicators.

Other non-limiting examples provide one or more computer storage devices having a first computer-executable instructions stored thereon for providing multi-object cluster detection. When executed by a computer, the computer performs operations including obtaining, from an image capture device, an image of an item storage structure using a multi-object cluster detection model; detecting a plurality of clusters of interest associated with a plurality of object types within the image, the plurality of clusters of interest comprising a first cluster of items associated with a first object type and a second cluster of items associated with a second object type; generating a labeled image comprising a plurality of indicators within an overlay associated with the image, the plurality of indicators comprising a first cluster indicator associated with the first cluster of items of interest within the image and a second cluster indicator associated with the second cluster of items of interest within the image; and identifying a number of unique clusters of items associated with a location within a retail facility corresponding to the plurality of clusters of interest detected within the labeled image using the plurality of indicators.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A” and “B” (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of”only one of or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than “A”); in yet another embodiment, to at least one, optionally including more than one, “A”, and at least one, optionally including more than one, “B” (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for multi-object cluster detection with improved accuracy, the system comprising:
a computer-readable medium storing instructions that are operative upon execution by a processor to:
obtain an image of an item storage structure captured by an image capture device using a multi-object cluster detection model;
detect a plurality of clusters of items of interest associated with a plurality of object types within the image, the plurality of clusters comprising a first cluster of items associated with a first object type and a second cluster of items associated with a second object type;
generate a labeled image comprising a plurality of indicators within an overlay associated with the image, the plurality of indicators comprising a first cluster indicator associated with the first cluster of items within the image and a second cluster indicator associated with the second cluster of items within the image; and
identify a number of unique clusters of items associated with a location corresponding to the plurality of clusters detected within the labeled image using the plurality of indicators.

2. The system of claim 1, wherein the instructions are further operative to:
determine whether the identified number of unique clusters of items equals an expected number of unique clusters of items; and
responsive to the identified number of unique clusters of items exceeding the expected number of unique clusters of items, generate a notification indicating at least one incorrectly placed item at the location.

3. The system of claim 2, wherein the instructions are further operative to:
responsive to the expected number of unique clusters of items exceeding the identified number of unique clusters of items, generate an item out notification indicating at least one out-of-stock item.

4. The system of claim 1, wherein the instructions are further operative to:
validate item identification of at least one item associated with the location using the identified number of unique clusters.

5. The system of claim 1, wherein the instructions are further operative to:
analyze the image using a set of parameters for distinguishing unique items, the set of parameters comprising size, shape, color, and proximity; and
detect a first cluster comprising at least one instance of a first type of item and a second cluster comprising at least one instance of a second type of item, wherein the first type of item has at least one different attribute than the second type of item, an attribute comprising at least one of a size, shape, and color.

6. The system of claim 1, wherein the instructions are further operative to:
detect, by the multi-object cluster detection model, a cluster of items comprising at least one instance of an item, wherein each instance of an item in the cluster of items is located within a predetermined proximity to at least one other item having similar size, shape, and color;
identify a location tag on at least a portion of the item storage structure associated with the detected cluster of items;
determine the location of the cluster of items using the location tag; and
store the determined location of the cluster of items in a database.

7. The system of claim 1, wherein the instructions are further operative to:
map a current location of each unique cluster of items in the plurality of clusters of items to a location of a portion of the item storage structure in a database using image data associated with the labeled image.

8. A method for multi-object cluster detection with improved accuracy, the method comprising:
obtaining, from an image capture device, an image of an item storage structure using a multi-object cluster detection model;
detecting a plurality of clusters of items associated with a plurality of object types within the image, the plurality of clusters of items comprising a first cluster of items associated with a first object type and a second cluster of items associated with a second object type;
generating a labeled image comprising a plurality of indicators within an overlay associated with the image, the plurality of indicators comprising a first cluster indicator associated with the first cluster of items within the image and a second cluster indicator associated with the second cluster of items within the image; and
identifying a number of unique clusters of items associated with a location corresponding to the plurality of clusters of items detected within the labeled image using the plurality of indicators.

9. The method of claim 8, further comprising:
determining whether the identified number of unique clusters of items falls within a threshold range of unique clusters of items; and
responsive to the identified number of unique clusters of items exceeding the threshold range of unique clusters of items, generating a notification indicating at least one incorrectly placed item at the location.

10. The method of claim 9, further comprising:
responsive to the identified number of unique clusters of items falling below the threshold range, generating an alert indicating at least one out-of-stock item.

11. The method of claim 8, further comprising:
validating item identification of at least one item associated with the location using the identified number of unique clusters.

12. The method of claim 8, further comprising:
analyzing the image using a set of parameters for distinguishing unique items, the set of parameters comprising size, shape, color, and proximity; and
detecting a first cluster comprising at least one instance of a first type of item and a second cluster comprising at least one instance of a second type of item, wherein the first type of item has at least one of a different size, shape, and color than the second type of item.

13. The method of claim 8, further comprising:
detecting, by the multi-object cluster detection model, a cluster of items having similar size, shape, and color, wherein each instance of an item in the cluster of items is located within a predetermined proximity to at least one other item having the similar size, shape, and color;
identifying a location tag on at least a portion of the item storage structure associated with the cluster of items;
determining the location of the cluster of items using the location tag; and
storing the location of the detected cluster of items in a database.

14. The method of claim 8, further comprising:
mapping a current location of each unique cluster of items in the plurality of clusters of items to a location of a portion of the item storage structure in a database using image data associated with the labeled image.

15. One or more computer storage devices having computer-executable instructions stored thereon, which, upon execution by a computer, cause the computer to perform operations comprising:
obtaining an image of an item storage structure captured by an image capture device using a multi-object cluster detection model;
detecting a plurality of clusters of items of interest associated with a plurality of object types within the image, the plurality of clusters of items comprising a first cluster of items associated with a first object type and a second cluster of items associated with a second object type;
generating a labeled image comprising a plurality of indicators within an overlay associated with the image, the plurality of indicators comprising a first cluster indicator associated with the first cluster of items within the image and a second cluster indicator associated with the second cluster of items within the image; and
identifying a number of unique clusters of items associated with a location corresponding to the plurality of clusters of items detected within the labeled image using the plurality of indicators.

16. The one or more computer storage devices of claim 15, wherein the operations further comprise:
responsive to the identified number of unique clusters of items exceeding an expected number of unique clusters of items, generating a first notification indicating at least one incorrectly placed item at the location; and
responsive to the expected number of unique clusters of items exceeding the identified number of unique clusters of items, generating a second notification indicating at least one out-of-stock item.

17. The one or more computer storage devices of claim 15, wherein the operations further comprise:
validating item identification of at least one item associated with the location using the identified number of unique clusters.

18. The one or more computer storage devices of claim 15, wherein the operations further comprise:
analyzing the image using a set of parameters for distinguishing unique items, the set of parameters comprising size, shape, color, and proximity; and
detecting a first cluster comprising at least one instance of a first type of item and a second cluster comprising at least one instance of a second type of item, wherein the first type of item has at least one of a different size, shape, and color than the second type of item.

19. The one or more computer storage devices of claim 15, wherein the operations further comprise:
detecting, by the multi-object cluster detection model, a cluster of items comprising at least one instance of an item, wherein each instance of an item in the cluster of items is located within a predetermined proximity to at least one other item having a same size, shape, and color;
identifying a location tag on at least a portion of the item storage structure associated with the cluster of items;
determining the location of the cluster of items using the location tag; and
storing the determined location of the cluster of items in a database.

20. The one or more computer storage devices of claim 15, wherein the operations further comprise:
mapping a current location of each unique cluster of items in the plurality of clusters of items to a location of a portion of the item storage structure in a database using image data associated with the labeled image.
